(19) United States
(12) Patent Application Publication
(10) Pub. No.: US 2009/0046291 A1
(43) Pub. Date: Feb. 19, 2009

(54) DEVICE FOR IMAGING AN INTERIOR OF A TURBID MEDIUM

(75) Inventors: Martinus Bernadus Van Der Mark, Eindhoven (NL); Michael Cornelis Van Beek, Eindhoven (NL); Levinus Pieter Bakker, Eindhoven (NL); arnoldus Johannes Martinus Jozeph Ras, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/093,964

(22) PCT Filed: Oct. 27, 2006
(86) PCT No.: PCT/IB2006/053972

§ 371 Date: May 16, 2008

(30) Foreign Application Priority Data
Nov. 18, 2005 (EP) 05110972.6

(51) Int. Cl. G01N 21/49

(52) U.S. Cl. 356/440

(57) ABSTRACT

The invention relates to a device (1) for imaging an interior of a turbid medium (55) comprising a receptacle (20) with the receptacle (20) comprising a measurement volume (15) for receiving the turbid medium (55). The device (1) is adapted such that the device (1) further comprises a further receptacle (60), arranged to be inserted into the receptacle (20), with the further receptacle (60) comprising a restricted measurement volume (75) for receiving the turbid medium (55).

The invention relates to a device for imaging an interior of a turbid medium comprising a receptacle with the receptacle comprising a measurement volume for receiving the turbid medium and with the receptacle comprising optical channels for optically coupling a light source to the measurement volume. The invention also relates to a medical image acquisition device comprising the device. The invention also relates to a further receptacle, arranged to be inserted into a receptacle, with the receptacle being comprised in a device for imaging an interior of a turbid medium.

An embodiment of a device of this kind is known from U.S. Pat. No. 6,327,488 B1. The known device can be used for imaging an interior of a turbid medium, such as biological tissues. In medical diagnostics the device may be used for imaging an interior of a female breast. The measurement volume receives a turbid medium, such as a breast. The measurement volume may be bound by a holder having only one open side, with the open side being bound by an edge portion. This edge portion may be provided with an elastically deformable sealing ring. Such a holder is known from U.S. Pat. No. 6,480,281 B1. Light is applied to the turbid medium by irradiating the turbid medium from a position that is successively chosen from a number of positions. Light emanating from the measurement volume via further positions selected from the number of positions is detected by a detector unit and is used to derive an image of the interior of the turbid medium.

It is a drawback of the known device that the use of a receptacle standardized along the principle of ‘one size fits many’ does not always provide an optimal fit for turbid mediums. With such a receptacle a turbid medium may fill only a small part of the measurement volume resulting in a less than optimal fit. In the known device the space between the receptacle and the turbid medium may be filled with an adaptation fluid to counteract boundary effects stemming from the optical coupling of the turbid medium with its surroundings. However, this measure leads to a loss of light in the space between the receptacle and the turbid medium and also leads to a broadening of light paths inside the space between the receptacle and the turbid medium. This broadening of light paths results in a lower image resolution or a more difficult image reconstruction process. Additionally, use of a receptacle standardized along the ‘one size fits many’ principle means that some turbid mediums, for instance some female breasts, may be too large to be accommodated inside the measurement volume.

It is an object of the invention to adapt the device such that it is possible to provide a better fit for a turbid medium inside the measurement volume. According to the invention this object is realized in that the device further comprises a further receptacle arranged to be inserted into the receptacle, with the further receptacle comprising a restricted measurement volume for receiving the turbid medium and with the further receptacle comprising further optical channels for optically coupling the light source to the restricted measurement volume, with each further optical channel comprising a first end for optically coupling the receptacle to the further receptacle and a second end for optically coupling the further receptacle to the restricted measurement volume.

The invention is based on the recognition that use of a receptacle together with a further receptacle that can be inserted into the receptacle allows the dimensions of the restricted measurement volume bounded by the further receptacle to be chosen such that the turbid medium inside the restricted measurement volume is provided with a better fit. It is an additional advantage that use of a further receptacle is hygienic, as the further receptacle can be removed from the receptacle and easily cleaned.

An embodiment of the device according to the invention is characterized in that the device comprises means for positioning and aligning the further receptacle in the receptacle. Properly positioning and aligning the further receptacle in the receptacle may be necessary, for instance, for properly irradiating the turbid medium inside the restricted measurement volume. If, for instance, the further receptacle comprises optical channels, these optical channels must be positioned and aligned such that light from a light source can reach the restricted measurement volume. In medical diagnostics, where the device may be used to image female breasts, proper positioning and alignment of the further receptacle in the receptacle may also be necessary with respect to a patient's position. Possible means for positioning and aligning the further receptacle in the receptacle may, for instance, comprise any of the following means: a notch, a groove, a ridge, a line, and an optical reference channel.

A further embodiment of the device according to the invention is characterized in that the device comprises means for removing the further receptacle inserted into the receptacle from the receptacle. To provide the best fit for a specific turbid medium inside the restricted measurement volume it must be possible to insert that further receptacle that bounds the restricted measurement volume that offers the best fit for that turbid medium. Consequently, it must be possible to insert and remove a further receptacle inserted in the receptacle from that receptacle. Possible means for removing a further receptacle from the receptacle may, for instance, comprise any of the following means: a handle, a grip, a peg, and a gas inlet for introducing a gas in a space between the receptacle and the further receptacle, with the gas being at a pressure exceeding the ambient air pressure.

A further embodiment of the device according to the invention is characterized in that the device comprises means for enhancing the optical coupling between the receptacle and the further receptacle. As the turbid medium inside the restricted measurement volume is irradiated with light from a light source during a measurement, and as this light has to go from the receptacle to the further receptacle before it enters the restricted measurement volume, there must be an adequate optical coupling between the receptacle and the further receptacle. Possible means for enhancing the optical coupling between the receptacle and the further receptacle may comprise any of the following means: a lens, a mirror, an optical fiber, an optical channel having a inner surface reflecting light used in a measurement, an optical channel having an inner surface absorbing light used in a measurement, and an optical channel with a number of stops.

A further embodiment of the device according to the invention is characterized in that the device comprises means for reducing crosstalk in the space between the receptacle and the further receptacle. Inserting a further receptacle into the receptacle and communicating light from a light source to the restricted measurement volume via the receptacle and the further receptacle holds the risk that crosstalk might occur in the space between the receptacle and the further receptacle. In such a situation, light leaving the receptacle at one location would enter and leave the further receptacle at multiple locations. Instead of irradiating the turbid medium inside the restricted measurement volume from only one location at a time, the turbid medium would be irradiated from multiple positions hampering the image reconstruction process. Also, light leaving the receptacle at one location would directly re-enter the receptacle at another location and be detected without having passed through the restricted measurement volume. Instead of irradiating the turbid medium inside the restricted measurement volume, the light would go directly into the receiving channels, thereby giving rise to false information about the distribution of light that actually emanates from the restricted measurement volume. L Consequently, means for reducing crosstalk in the space between the receptacle and the further receptacle are necessary. Possible means for reducing crosstalk in the space between the receptacle and the further receptacle comprise any of the following means: a ridge, stepwise changing radii of optical channels, stepwise changing radii of a surface of the receptacle facing the measurement volume, stepwise changing radii of a surface of the further receptacle facing away from the restricted measurement volume, minimizing the space between a surface of the receptacle facing the measurement volume and a surface of the further receptacle facing away from the restricted measurement volume, a medium absorbing light used in a measurement located in the space between a surface of the receptacle facing the measurement volume and a surface of the further receptacle facing away from the restricted measurement volume, a surface of the receptacle that faces the measurement volume and that absorbs light used in a measurement, and a surface of the further receptacle that faces away from the restricted measurement volume that absorbs light used in a measurement. The advantage of this embodiment is that the means are relatively easy to implement.

A further embodiment of the device according to the invention is characterized in that the further optical channels comprise means for filtering light. During measurements use may be made of substances like fluorescent contrast agents. With such measurements it is often customary to use optical filters in such a way that only light within a certain range of wavelengths or light having a wavelength or frequency exceeding a certain wavelength or frequency is detected. In this way information can be obtained using light emitted by the fluorescent contrast agents used. It is an advantage of this embodiment that means for filtering light can be easily implemented in a further receptacle, allowing easy adaptation of the device to new measurement requirements.

A further embodiment of the device according to the invention is characterized in that the further receptacle has an open side bounded by an edge portion with the edge portion comprising means for attaching a sealing ring. Use of a sealing ring is known per se from U.S. Pat. No. 6,480,281 B1. In the known device the space between the receptacle and the turbid medium may be filled with an adaptation fluid to prevent an optical short circuit from occurring around the turbid medium to be examined and to counteract boundary effects stemming from the optical coupling between the turbid medium and its surroundings. If, for instance, the known device is used to image an interior of a female breast, a sealing ring may be used between the receptacle and a patient's body in order to fully fill the space between the receptacle and the turbid medium with adaptation fluid. Additionally, a sealing ring may provide a patient with a more comfortable interface to the receptacle. The above is also true when using a further receptacle that can be inserted into the receptacle. In that case it may be necessary to fully fill the restricted measurement volume with an adaptation medium and to provide a patient with a comfortable interface. Consequently, it may be necessary to provide a further receptacle with means for attaching a sealing ring. Possible means may comprise any of the following means: a ridge, a groove, and a peg.

A further embodiment of the device according to the invention is characterized in that the further receptacle comprises means for creating optimal boundary conditions for image reconstruction. These means may comprise any of the following means: a surface of the further receptacle facing the restricted measurement volume that absorbs light used in a measurement, a surface of the further receptacle facing the restricted measurement volume that reflects light used in a measurement, a surface of the further receptacle facing the restricted measurement volume that has optical properties similar to those of the turbid medium. It is the purpose of the device to obtain an image of an interior of the turbid medium inside a measurement volume by irradiating the turbid medium with light from a light source, detecting light emanating from the measurement volume, and performing an image reconstruction process using detected light. To facilitate the image reconstruction process for measurements in which a further receptacle was used, it is helpful to exactly know the boundary conditions at the boundary of the restricted measurement volume. This can be achieved by choosing the optical properties of the further receptacle so that, as a consequence, the boundary conditions for the image reconstruction process are known. In this sense the boundary conditions are optimal. Depending on the kind of measurement and the image reconstruction process different boundary conditions may be desirable. ‘Optical properties similar to those of the turbid medium’ also covers optical properties that are averaged over a group of turbid mediums that may be imaged using the device.

A further embodiment of the device according to the invention is characterized in that the further receptacle comprises a surface facing the restricted measurement volume and in that the surface and the second end of at least one of the further optical channels are covered by a continuous layer.

By covering the surface of the further receptacle that faces the measurement volume and at least one of the second ends of the further optical channels comprised in the further receptacle with a layer of material, a continuous surface is created that protects the covered further optical channels from damage and is easy to clean. Additionally, the layer may be used to prevent certain objects from coming into contact with the restricted measurement volume. Such objects may include, for instance, ultrasonic equipment that may be used for additional measurements or objects used to assemble the further receptacle, such as, bolts. Furthermore, the layer may be used to diffuse light exiting from the second ends of covered further optical channels and entering the restricted measurement volume. Diffuse light has the advantage of being safer for people working with the device. If the device is used in medical diagnostics for, for instance, the imaging of a female breast, these people include patients who may look into the restricted measurement volume before and after a breast is accommodated in the restricted measurement volume. If the layer is used to diffuse light, the optical properties of the layer must be chosen such that the layer is sufficiently transparent for light exiting the second end of a covered further optical channel in a direction substantially perpendicular to the layer and entering the restricted measurement volume, so that a sufficient amount of light enters the restricted measurement volume. However, at the same time the optical properties of the layer must be chosen such that the layer is sufficiently absorbent for light exiting the second end of a covered further optical channel and traveling through the layer without entering the restricted measurement volume so that only an insignificant amount of light might reach the second end of a neighboring further optical channel. Polyoxymethylene is an example of the material that has the required optical properties. Alternatively, the layer may be made of a material such as welders' glass. This embodiment has the additional advantage that the optical properties of the layer may be chosen such that the optical properties of the layer are similar to the optical properties of the turbid medium. ‘Optical properties similar to those of the turbid medium’ also covers optical properties that are averaged over a group of turbid mediums that may be imaged using the device. A material that has such optical properties is polyoxymethylene.

According to the invention the medical image acquisition device comprises the device according to any of the previous embodiments. If, for instance, the device is used to image an interior of a female breast, as is done in medical diagnostics, the device would benefit from any of the previous embodiments.

According to the invention the further receptacle is arranged to be inserted into a receptacle and comprises further optical channels, with the receptacle being comprised in a device for imaging an interior of a turbid medium. Such a further receptacle would have such dimensions that it closely fits in a receptacle.

These and other aspects of the invention will be further elucidated and described with reference to the drawings, in which:

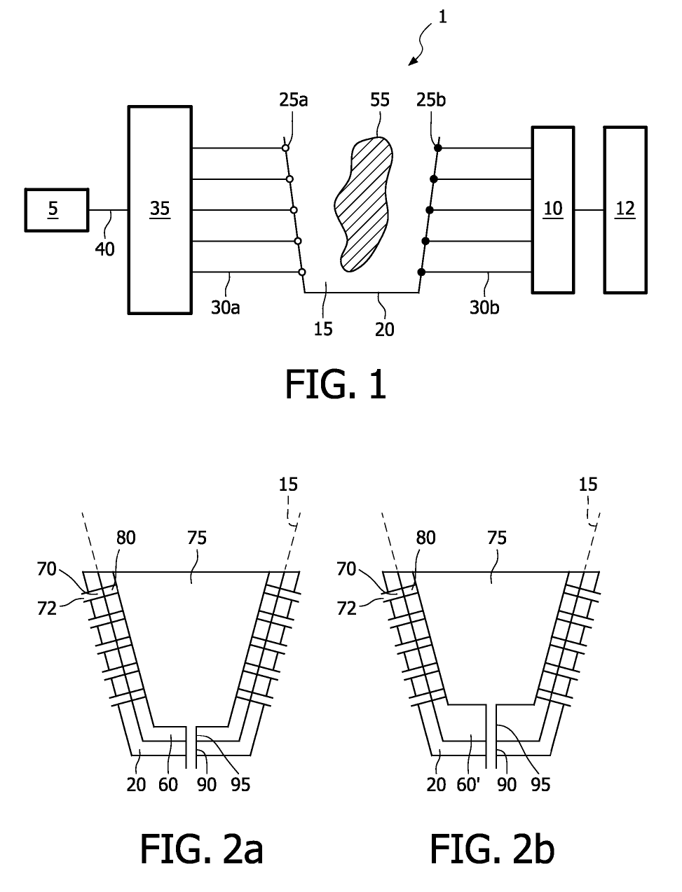

FIG. 1 schematically shows an embodiment of a device for performing measurements on a turbid medium,

FIGS. 2a and 2b schematically show a receptacle together with a further receptacle,

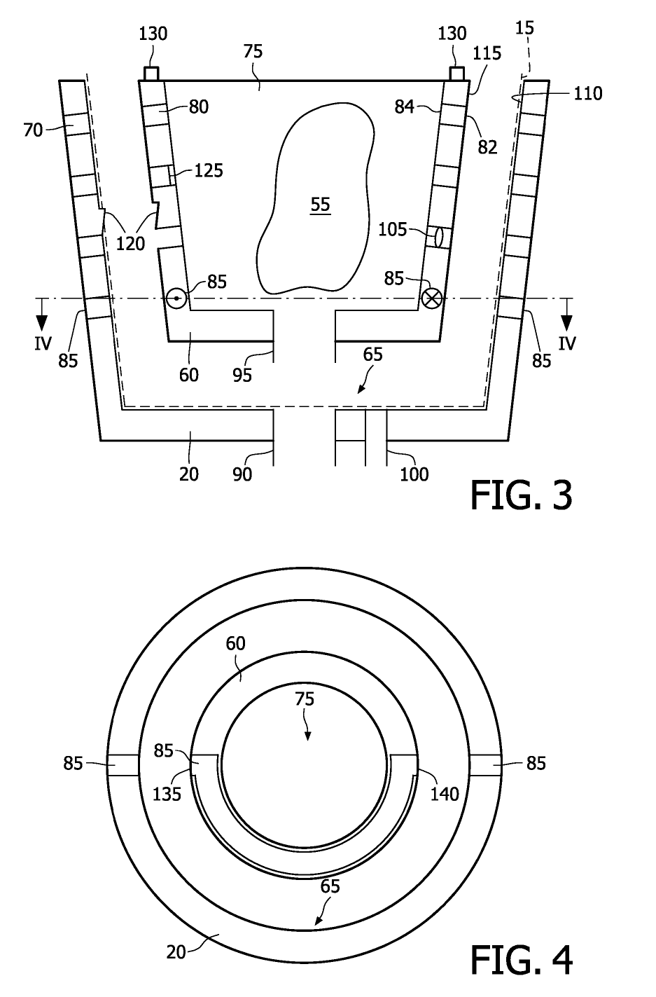

FIG. 3 schematically shows a receptacle together with a further receptacle in more detail,

FIG. 4 schematically shows a cross-section along the line IV-IV in FIG. 3, showing a top view of an optical reference channel in the receptacle and the further receptacle,

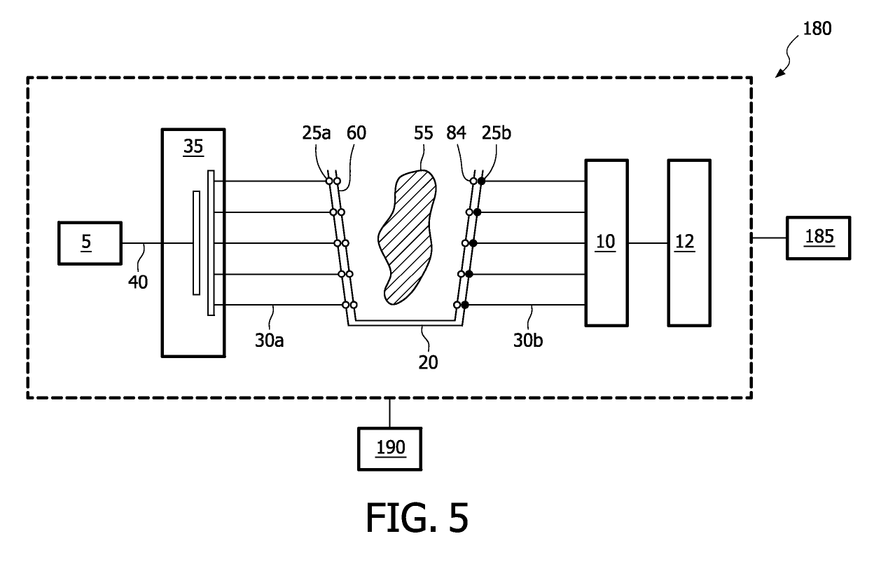

FIG. 5 schematically shows an embodiment of a medical image acquisition device according to the invention.

FIG. 1 schematically shows an embodiment of a device for imaging an interior of a turbid medium. The device 1 includes a light source 5, a photodetector unit 10, an image reconstruction unit 12 for reconstructing an image of an interior of the turbid medium 55 based on light detected using the photodetector unit 10, a measurement volume 15 bound by a receptacle 20, said receptacle 20 comprising a plurality of entrance positions for light 25a and a plurality of exit positions for light 25b, and light guides 30a and 30b coupled to said entrance and exit positions. The device 1 further includes a selection unit 35 for coupling the light source 5 to a number of selected entrance positions for light 25a in the receptacle 20. The light source 5 is coupled to the selection unit 35 using input light guides 40. For the sake of clarity, entrance positions for light 25a and exit positions for light 25b have been positioned at opposite sides of the receptacle 20. In reality, however, both types of positions may be spread around the measurement volume 15. A turbid medium 55 is accommodated in the measurement volume 15. The turbid medium 55 is then irradiated with light from the light source 5 from a plurality of positions by coupling the light source 5 using the selection unit 35 to successively selected entrance positions for light 25a. Light emanating from the measurement volume 15 is detected from a plurality of positions using exit positions for light 25b and using photodetector unit 10. The detected light is then used to derive an image of an interior of the turbid medium 55. This reconstruction process, which is based on, for example, an algebraic reconstruction technique or a finite element method finds the most likely solution to the inverse problem.

FIGS. 2a and 2b schematically show a receptacle 20 together with a further receptacle 60 inserted into the receptacle 20. The receptacle 20 comprises optical channels 70 for optically coupling the light source 5 (see FIG. 1) to the measurement volume 15 indicated by a dashed line in FIGS. 2a and 2b. The further receptacle 60 comprises further optical channels 80 for optically coupling selected optical channels of the receptacle 20 to the restricted measurement volume 75. For further receptacles 60 variable sizes can be used to adjust the size of the restricted measurement volume 75. By way of illustration FIG. 2a shows a further receptacle 60 bounding a larger restricted measurement volume 75, whereas FIG. 2b shows a further receptacle 60′ bounding a smaller restricted measurement volume 75. Also shown in FIGS. 2a and 2b are an optical fiber 72 coupled to the receptacle 20 and in- and outlets 90 and 95 for an adaptation medium.

FIG. 3 schematically shows a receptacle 20 together with a further receptacle 60 in more detail. For the sake of clarity, the space 65 between the receptacle 20 and the further receptacle 60 has been exaggerated. In reality, the further receptacle 60 closely fits in the receptacle 20. The receptacle 20 comprises a measurement volume 15, indicated by a dashed line in FIG. 3, for receiving the turbid medium 55 or the further receptacle 60. The receptacle 20 comprises optical channels 70 for optically coupling the light source 5 (see FIG. 1) to the measurement volume 15. The further receptacle 60 comprises a restricted measurement volume 75 for receiving the turbid medium 55 and further comprises further optical channels 80 for optically coupling selected optical channels of the receptacle 20 to the restricted measurement volume 75. Each further optical channel 80 has a first end 82 for optically coupling the receptacle 20 to the further receptacle 60 and a second end 84 for optically coupling the further receptacle 60 to the restricted measurement volume 75. An optical reference channel 85 may be present for positioning and aligning the further receptacle 60 inside the receptacle 20. The optical reference channel 85 directly couples the light source 5 to the photodetector unit 10, without the signal entering the restricted measurement volume 75. Multicore optical fibers may be used to guide light through the optical channels 70, the further optical channels 80, and the optical reference channel 85. FIG. 3 also shows that it may be possible to administer and remove an adaptation medium. For these purposes the receptacle 20 and the further receptacle 60 may be arranged to comprise an in-and outlet 90 and a further in- and outlet 95 respectively. FIG. 3 further shows that the device may comprise means for removing the further receptacle 60 from the receptacle 20. These means may include a gas inlet 100 for introducing a gas in the space 65 between the receptacle 20 and the further receptacle 60. In FIG. 3 the inlet 100 has been coupled to the receptacle 20. FIG. 3 further schematically shows that the device may comprise means for enhancing the optical coupling between the receptacle 20 and the further receptacle 60. These means may include a lens 105, an optical fiber, a mirror, an optical channel having an absorbing inner surface, and an optical channel with a number of stops. For the sake of clarity only the lens 105 is indicated in the further receptacle 60 in FIG. 3. Means for enhancing the optical coupling between the receptacle 20 and the further receptacle 60 may be comprised in the receptacle 20, the further receptacle 60, as shown in FIG. 3 with the lens 105, or both. Also shown is that the device may comprise means for reducing crosstalk between the optical channels 70 of the receptacle 20 and the further optical channels 80 of the further receptacle 60. These means may include providing the receptacle 20 with a rough surface 110 facing the measurement volume 15 that absorbs light used in a measurement and the further receptacle 60 with a rough surface 115 facing away from the restricted measurement volume 75 that absorbs light used in a measurement. These means may further include a medium in the space 65 absorbing light used in a measurement (for the sake of clarity the absorbing medium is not shown in FIG. 3), and mechanical barriers 120 (for the sake of clarity only one type of mechanical barrier is shown in only one location). It is also shown that the device may comprise means for the filtering of light, such as an optical filter 125. In FIG. 3 the optical filter 125 has been positioned in a further optical channel 80 of the further receptacle 60 as an illustration. FIG. 3 further schematically shows that the further receptacle 60 may comprise means 130 for attaching a sealing ring. It is clear from FIG. 3 that by choosing the thickness of the wall of the further receptacle 60 the dimensions of the restricted measurement volume 75 may be adapted to provide the turbid medium 55 with a better fit. The receptacle 20 and the further receptacle 60 may have an electrical, optical, mechanical, or fluidic coupling with each other. An electrical coupling may be used for, for instance, heating of the adaptation medium or the operation of integrated ultrasonic equipment, LEDs, additional photodetectors or pressure sensors. An optical coupling may be used for, for instance, measurement and a safety switch. A mechanical coupling may be used for, for instance, a sensor for identifying the size of the receptacle or the further receptacle. A fluidic coupling may be used for, for instance, administering and removing an adaptation fluid. The further receptacle 60 comprises a surface facing the restricted measurement volume 75. This surface and the second end 84 of at least one of the further optical channels 80 may be covered by a continuous layer (layer not shown in FIG. 3). Applications of such a layer may be, for instance, to diffuse or absorb light exiting the second end 84 of a further optical channel 80. If the layer is used to diffuse light, the optical properties of the layer must be chosen such that the layer is sufficiently transparent for light exiting the second end 84 of a covered further optical channel 80 in a direction substantially perpendicular to the layer and entering the restricted measurement volume 75, so that a sufficient amount of light enters the restricted measurement volume 75. However, at the same time the optical properties of the layer must be chosen such that the layer is sufficiently absorbent for light exiting the second end 84 of a covered further optical channel 80 and traveling through the layer without entering the restricted measurement volume 75 so that only an insignificant amount of light might reach the second end 84 of a neighboring further optical channel 80. Polyoxymethylene is an example of the material that has the required optical properties. Alternatively, the layer may be made of a material such as welders' glass. In that case, light exiting the second end 84 of a covered further optical channel 80 will be diffuse less than if a material such as polyoxymethylene were used. However, a material such as welders' glass absorbs light more strongly than a material such as polyoxymethylene. So there is a range of materials with on the one end materials such as polyoxymethylene that diffuse light, but absorb light relatively weakly and materials such as welders' glass on the other end that basically do not diffuse light, but absorb light relatively strongly. Optimal conditions may be created by choosing the layer material and layer thickness.

FIG. 4 schematically shows a cross-section along the line III-III in FIG. 3, showing a top view of the optical reference channel 85 in the receptacle 20 and the further receptacle 60. The optical reference channel 85 passes through the further receptacle 60 without the signal carried by the optical reference channel 85 entering the restricted measurement volume 75. A multicore optical fiber may be used in the optical reference channel 85 to guide the signal. By way of illustration, the points 135 and 140, where the optical reference channel 85 enters and exits the further receptacle 60 respectively are positioned opposite to one another. However, this is not a necessity. For the sake of clarity, the space 65 between the receptacle 20 and the further receptacle 60 has again been exaggerated.

FIG. 5 shows embodiment of a medical image acquisition device according to the invention. The medical image acquisition device 180 comprises the device 1 discussed in FIG. 1 as indicated by the dashed square. In addition to the device 1 the medical image acquisition device 180 further comprises a further receptacle 60, a screen 185 for displaying an image of an interior of the turbid medium 45 and an input interface 190, for instance, a keyboard enabling and operated to interact with the medical image acquisition device 180.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the system claims enumerating several means, several of these means can be embodied by one and the same item of computer readable software or hardware. The mere fact that certain measures are recited in mutually different dependent claims does not indicate that a combination of these measures cannot be used to advantage.

1. A device (1) for imaging an interior of a turbid medium (55) comprising a receptacle (20) with the receptacle (20) comprising a measurement volume (15) for receiving the turbid medium (55) and with the receptacle (20) comprising optical channels (70) for optically coupling a light source (5) to the measurement volume (15)
characterized in that
the device (1) further comprises a further receptacle (60) arranged to be inserted into the receptacle (20), with the further receptacle (60) comprising a restricted measurement volume (75) for receiving the turbid medium (55) and with the further receptacle (60) comprising further optical channels (80) for optically coupling the light source (5) to the restricted measurement volume (75), with each further optical channel (80) comprising a first end for optically coupling the receptacle (20) to the further receptacle (60) and a second end for optically coupling the further receptacle (60) to the restricted measurement volume (75).

2. A device (1) as claimed in claim 1, wherein the device (1) comprises means (85) for positioning and aligning the further receptacle (60) in the receptacle (20).

3. A device (1) as claimed in claim 1, wherein the device (1) comprises means (100) for removing the further receptacle (60) inserted into the receptacle (20) from the receptacle (20).

4. A device (1) as claimed in claim 1, wherein the device (1) comprises means (105) for enhancing the optical coupling between the receptacle (20) and the further receptacle (60).

5. A device (1) as claimed in claim 1, wherein the device (1) comprises means (110, 115, 120) for reducing crosstalk in the space (65) between the receptacle (20) and the further receptacle (60).

6. A device (1) as claimed in claim 1, wherein the further optical channels (80) comprise means (125) for filtering light.

7. A device (1) as claimed in claim 1, wherein the further receptacle (60) has an open side bounded by an edge portion with the edge portion comprising means (130) for attaching a sealing ring.

8. A device (1) as claimed in claim 1, wherein the further receptacle (60) comprises means for creating optimal boundary conditions for image reconstruction.

9. A device (1) as claimed in claim 1, wherein the further receptacle (60) comprises a surface facing the restricted measurement volume (75) and wherein the surface and the second end of at least one of the further optical channels (80) are covered by a continuous layer.

10. A medical image acquisition device comprising the device (1) according to claim 1.

11. A further receptacle (60), arranged to be inserted into a receptacle (20), and comprising further optical channels (80), with the receptacle (20) being comprised in a device (1) for imaging an interior of a turbid medium (55).
